(19) United States
(12) Patent Application Publication
(10) Pub. No.: US 2015/0271625 A1
(43) Pub. Date: Sep. 24, 2015

(54) HANDLING PACKET DATA UNITS

(71) Applicants: Canfeng Chen, Beijing (CN); Jia Liu, Beijing (CN); Kanji Kerai, London (GB)

(72) Inventors: Canfeng Chen, Beijing (CN); Jia Liu, Beijing (CN); Kanji Kerai, London (GB)

(21) Appl. No.: 14/414,416

(22) PCT Filed: Jul. 13, 2012
(86) PCT No.: PCT/CN2012/078599

§ 371 Date: May 25, 2015

(51) Int. Cl. H04W 4/00; H04M 3/02

(52) U.S. Cl. CPC H04W 4/008; H04M 3/02; H04M 2203/558

(57) ABSTRACT

Apparatus has at least one processor and at least one memory having computer-readable code stored thereon which when executed controls the at least one processor: to extract telephone number data from a received advertisement packet data unit [PDU]; to compare the telephone number data with telephone numbers present in a contacts database; and in the event of the comparison providing a match, to cause presentation of information from the contacts database relating to a contact with which a match was found.

### FIELD

The present application relates to handling packet data units. In particular, although not exclusively, it relates to the fields of Bluetooth communications and more specifically to Bluetooth Low Energy.

### BACKGROUND

Bluetooth Low Energy (BLE) is a new wireless communication technology published by the Bluetooth SIG as a component of Bluetooth Core Specification Version 4.0. BLE is a lower power, lower complexity, and lower cost wireless communication protocol, designed for applications requiring lower data rates and shorter duty cycles. Inheriting the protocol stack and star topology of classical Bluetooth, BLE redefines the physical layer specification, and involves many new features such as a very-low power idle mode, a simple device discovery, and short data packets, etc.

BLE technology is aimed at devices requiring a low power consumption, for example devices that may operate with one or more button cell batteries such as sensors, key fobs, and/or the like. BLE can also be incorporated into devices such as mobile phones, smart phones, tablet computers, laptop computers, desktop computers etc.

### SUMMARY

Various aspects of examples of the invention are set out in the claims.

According to a first aspect of the present invention, an apparatus configured:
to extract telephone number data from a received advertisement packet data unit [PDU];
to compare the telephone number data with telephone numbers present in a contacts database; and
in the event of the comparison providing a match, to cause presentation of information from the contacts database relating to a contact with which a match was found.

The apparatus may be configured:
to receive the advertisement packet data unit [PDU];
to determine from the PDU whether the PDU includes telephone number data as an identifier of a device from which the PDU was transmitted; and
in response to a positive determination:
   to extract the telephone number data from the PDU;
   to compare the telephone number data with the telephone numbers present in the contacts database; and
   in the event of the comparison providing a match, to cause the presentation of information from the contacts database relating to the contact with which the match was found.

The apparatus may be configured in response to a negative determination by causing presentation of device name information included in the PDU.

The apparatus may be configured, in the event of the comparison providing a match, to cause presentation of contact name information from the contacts database relating to the contact with which a match was found.

The telephone number data may be a part of a telephone number and less than a whole of a telephone number, or the telephone number data may be a whole of a telephone number.

The contacts database is stored within the apparatus and/or within a SIM card included within the apparatus.

A second aspect of the invention provides apparatus configured:
to create an advertising message including a packet data unit [PDU] including telephone number information derived from a telephone number associated with the apparatus and an indication that the PDU includes telephone number information; and
to transmit the advertising message.

The telephone number information may be included in a phone number field and a counter value may be included in a counter value field.

The apparatus may be configured to change the counter value included in the counter value field between creation of successive advertising messages.

The counter value field may be a 12 bit field. The phone number field may be a 36 bit field.

The PDU may include a header and a payload and the telephone number information may be included in the payload.

The PDU may include a header and a payload, and the indication that the PDU includes telephone number information may be included in the header.

The indication that the PDU includes telephone number information may comprise one or more bits in a field of the header following a PDU Type field.

The PDU may include a header and a payload, and the indication that the PDU includes telephone number information may be included in the payload.

The indication that the PDU includes telephone number information may comprise one or more bits in an AD Type field of the payload. Here, the indication that the PDU includes telephone number information may comprise the data 0x20 in an AD Type field of the payload.

The telephone number data may be a part of a telephone number and may be less than a whole of a telephone number.

The telephone number data may be a whole of a telephone number.

The advertising message may be a Bluetooth Low Energy Link Layer packet.

A third aspect of the invention provides a method comprising:
extracting telephone number data from a received advertisement packet data unit [PDU];
comparing the telephone number data with telephone numbers present in a contacts database; and
in the event of the comparison providing a match, causing presentation of information from the contacts database relating to a contact with which a match was found.

A fourth aspect of the invention provides a method comprising:
creating an advertising message including a packet data unit [PDU] including telephone number information derived from a telephone number associated with the apparatus and an indication that the PDU includes telephone number information; and
transmitting the advertising message.

The invention also provides a computer program comprising instructions that when executed by a computer apparatus control it to perform the method above.

A fifth aspect of the invention provides a non-transitory computer-readable storage medium having stored thereon computer-readable code, which, when executed by computing apparatus, causes the computing apparatus to perform a method comprising:
extracting telephone number data from a received advertisement packet data unit [PDU];
comparing the telephone number data with telephone numbers present in a contacts database; and
in the event of the comparison providing a match, causing presentation of information from the contacts database relating to a contact with which a match was found.

A sixth aspect of the invention provides apparatus, the apparatus having at least one processor and at least one memory having computer-readable code stored thereon which when executed controls the at least one processor:
to extract telephone number data from a received advertisement packet data unit [PDU];
to compare the telephone number data with telephone numbers present in a contacts database; and
in the event of the comparison providing a match, to cause presentation of information from the contacts database relating to a contact with which a match was found.

According to various embodiments of the previous aspect of the present invention, the computer program according to any of the above aspects, may be implemented in a computer program product comprising a tangible computer-readable medium bearing computer program code embodied therein which can be used with the processor for the implementation of the functions described above.

The computer program instructions may arrive at the apparatus via an electromagnetic carrier signal or be copied from a physical entity such as a computer program product, a memory device or a record medium such as but not exclusively a CD-ROM or DVD, and/or an article of manufacture that tangibly embodies the computer program.

Reference to “computer-readable storage medium”, “computer program product”, “tangibly embodied computer program” etc, or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

### BRIEF DESCRIPTION OF THE DRAWINGS

For a more complete understanding of example embodiments of the present invention, reference is now made to the following descriptions taken in connection with the accompanying drawings in which:

FIG. 1 is a schematic diagram of two devices that are used to discuss the general principle of embodiments of the invention;

FIG. 2 presents the format of an Advertising Channel PDU used in embodiments of the invention;

FIG. 3 presents the PNA indication format used in a first group of embodiments of the invention;

FIG. 4 presents a PNA format used in the first group of embodiments of the invention;

FIG. 5 presents a GAP Advertising Data format used in a second group of embodiments of the invention;

FIG. 6 is a flow chart illustrating operation of a device operating as an advertiser;

FIG. 7 is a flow chart illustrating operation of a device operating as a scanner;

FIG. 8 is a schematic diagram of a Bluetooth device that may form one of the devices of FIG. 1;

FIG. 9 shows an example embodiment of a tangible memory media; and

FIG. 10 shows a software of an example embodiment of a Bluetooth device that may form one of the devices of FIG. 1.

### DETAILED DESCRIPTION OF VARIOUS EMBODIMENTS

The following acronyms are used in the specification and have the meanings referred to:
BLE: Bluetooth Low Energy
LE: Low Energy
BR/EDR: Basic Rate/Enhanced Data Rate
BT SIG: Bluetooth Special Interest Group
GAP: Generic Access Profile
PN: Phone Number
PNA: Phone Number Address
CC: Country (or Region) Code
RFU: Reserved for Future Use

The latest version of the BLE specification defines three advertising channels, which serve for device discovery and other broadcasting purpose. To identify BLE devices, two important identifies—Device Address and Device Name are highly relied upon.

According to the BLE specification, packets sent in the advertising channels (index=37, 38 and 39) shall contain the device addresses, which are used to identify a LE device. There are two types of device addresses: public device address and random device address, each of them is 48 bits in length, and a device shall contain at least one type of device address and may contain both.

Public Device Address

The content of a public device address contains two fields:
company_assigned field is in the 24 least significant bits
company_id field is in the 24 most significant bits

The public device address shall be created in accordance with section 9.2 (“48-bit universal LAN MAC addresses”) of the IEEE 802-2001 standard (http://standards.ieee.org/getieee802/download/802-2001.pdf) and using a valid Organizationally Unique Identifier (OUI) obtained from the IEEE Registration Authority (see http://standards.ieee.org/regauth/oui/forms/and sections 9 and 9.1 of the IEEE 802-2001 specification).

Random Device Address

A random device address is divided into the following two fields:
hash field is in the 24 least significant bits
random field is in the 24 most significant bits

The detailed specification of the hash field and random field can be found in BT Spec. v4.0, Vol. 3, Part C, Section 10.8.2.3 and Section 10.8.2.2, respectively.

On the other hand, the Generic Access Profile (GAP) also provides a Local Name AD Type to contain the device name in the BLE advertising data (BT Specification. v4.0, Vol. 3, Part C, Section 11.1.2).

Device Name

The Device Name is also known as user-friendly name. The Device Name is expected to facilitate the recognition and differentiation of Bluetooth devices for human users. The Device Name in GAP has several rules, including:
The Device Name characteristic shall encoded according to UTF-8
The Device Name characteristic value shall be 0 to 248 octets in length
A device shall have only one instance of the Device Name characteristic.

Instead of a complete Device Name, a shortened Device Name can be also used by containing contiguous characters from the beginning of the full name. For example, if the device name is ‘BT_Device_Name’ then the shortened name over BR/EDR could be ‘BT_Device’ while the shortened name on LE could be ‘BT_Dev’.

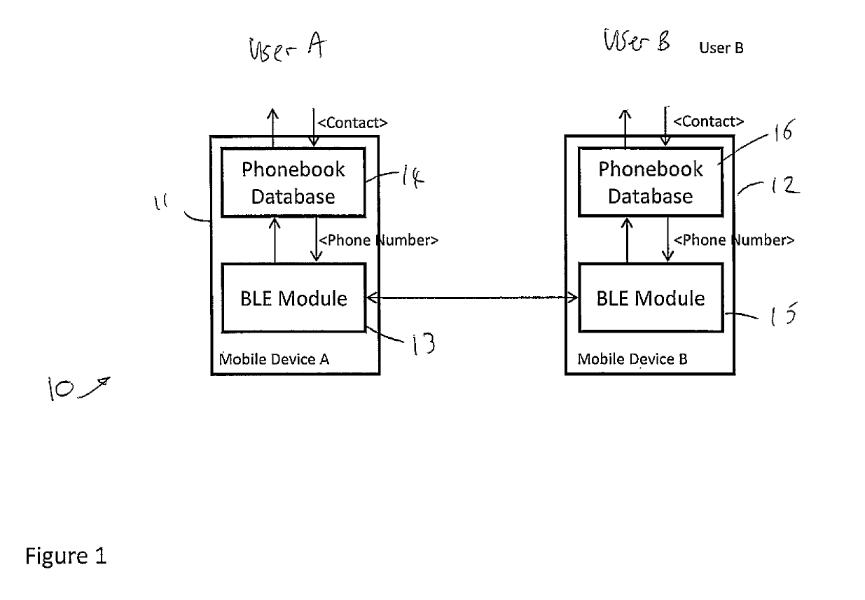

FIG. 1 shows a system according to embodiments of the invention. The system 10 includes a first device 11 and a second device 12. The first device 11 includes a BLE module 13, which operates according to the BLE standard. The second device 12 includes its own BLE module 15. The BLE module 15 also operates according to the BLE standard.

Each of the first and second devices 11, 12 includes a respective phonebook database 14, 16. The phonebook databases 14, 16 may also be referred to as contacts databases. As is discussed below, the phonebook databases 14, 16 may be stored solely within their respective device 11, 12, may be stored solely within one, two or more SIM cards included in the device 11, 12, or may be stored both within their respective device 11, 12, so and within one or more SIM cards included in the device 11, 12, In the case where the phonebook databases 14, 16 are stored both within their respective device 11, 12, and within one or more SIM cards included in the device 11, 12, there may or may not be overlap between (repetition of) contacts stored in the device 11, 12 and the contacts stored in the SIM card(s). SIM cards may be hardware SIM cards. One or more software SIM cards may be included in the one or more SIM cards, although usually at least one hardware SIM card will be present. Software SIM cards may simply be called SIMs.

Each of the devices 11, 12 includes a subscriber identity module (SIM) interface with which a SIM card may be received. This is described below in more detail with reference to FIG. 8. The SIM card allows the device 11, 12 to communicate via mobile telecommunication networks (not shown), in the usual way. The SIM card includes an International Mobile Subscriber Identity (IMSI). The SIM card has associated therewith a telephone number, although this typically is not stored on the SIM card. The telephone (phone) number is a number that can be used to reach the mobile device 11, 12 in which the SIM card is located. The telephone number is allocated by the issuer of the SIM card, which is typically a mobile network operator. The mobile network knows to route calls to the mobile device that includes the SIM card when a phone call is directed at the phone number. Similarly, short message service (SMS) messages are addressed to the SIM card, for presentation (e.g. display) through the mobile device 11, 12 in which the SIM card is located. Also, when a call is made from the device 11, 12, or an SMS is made from the device, the mobile network knows that the call or SMS originates from the SIM card by virtue of the telephone number stored on the SIM card.

The telephone number associated with the SIM card is known to the device 11, 12 in which it is incorporated. The telephone number can for instance be derived from a home location register (HLR) of a mobile network that issued the SIM card. The telephone number can be provided by the mobile network following transmission of the IMSI by the device 11, 12 to the network.

The mobile devices 11, 12 are operable to identify the phone number associated with the SIM card, for instance by accessing it from an HLR of a mobile network. The phone number read is stored within a memory within the mobile device 11, 12 and/or in a memory of the SIM card. For devices equipped two or more SIMs, the mobile device 11, 12 are operable to identify the phone numbers associated with all the SIMs. Alternatively the user could select one or more of multiple phone numbers, for instance by selecting them from a UI selection list. The mobile device 11, 12 may be configured to identify the phone number associated with the SIM each time the mobile device 11, 12 is switched on or rebooted, and update a phone number stored in the device accordingly.

The mobile devices 11, 12 may be mobile phones, smart phones, tablet computers, laptop computers etc. The mobile devices 11, 12 may be based around any suitable operating system, for instance the Symbian operating system or Microsoft Windows operating system, although any other operating system may instead be used. The devices 11, 12 may run different operating systems.

FIG. 1 illustrates an overview of principles of embodiments of the invention. A user of the first device 11 can enter contact information into the phonebook database 14 through a user interface, or by connection to an external device such as a desktop computer. As mentioned above, the phonebook database 14 may be stored solely within the device 11, solely within a SIM card included in the device 11, or may be stored both within the device 11, and within the SIM card. When receiving an advertising packet data unit (PDU) from another BLE device, such as the second device 12, the first device reads phone number information from the PDU. The device then uses this information to look up in the phonebook database 14 any contact that includes the phonebook information received as part of the PDU. This involves searching the phonebook database 14, which may be stored solely within the device 11, solely within the SIM card included in the device 11, or may be stored both within the device 11, and within the SIM card. If a match is found, the first device 11 informs the user of the identity of the contact in the phonebook database that includes the phone number information received from the second device 12. This may be provided in the form of a display of the name of the contact, or may be provided in any other suitable way.

The first device 11 is configured to include phone number information in advertising PDUs that are broadcast by the BLE module 13, for reception by other BLE devices. The phone number information is derived from the phone number of the SIM card that is included in the first device 11. The phone number information may for instance include the whole of the phone number, or only a part of the phone number (i.e. a truncated phone number), or may be derived from the phone number in some other way. The phone number information may also be termed telephone number data. For the avoidance of doubt, phone number information or data may be a whole phone number, a truncated phone number, or a number derived in some other way from a phone number. A number may be derived in some other way by applying a function to it, for instance a hash function, a rotate function, an add or subtract function, etc. Transmitting a number that is a function of the phone number improves security, although of course the receiving device needs to be able to apply the reverse function to derive the phone number.

The second device 12 may operate in the same way as the first device

This specification describes two main embodiments for including phone number information in an advertising PDU. The first is herein termed Phone Number Addressing (PNA). The second is herein termed Phone Number AD type. If the device 11, 12 has more than one SIM, and thus more than one phone number, the device 11, 12 may advertise all of the phone numbers of it may advertise only some of the phone numbers. Phone numbers for advertising may be selected by a user, for instance using a user interface provided by the device 1, 12. If plural phone numbers are advertised, they may be advertised alternately.

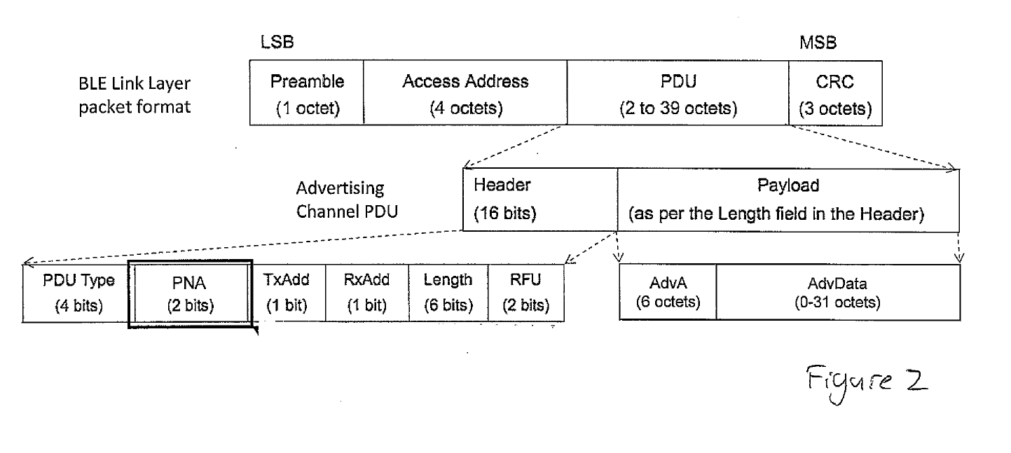

In Phone Number Addressing, the phone number information can be carried in the Device Address field of a message. In a BLE embodiment, the message is a BLE link layer packet, an example of which is shown in FIG. 2.

As shown in FIG. 2, there are four main components to the message. The first part is a preamble. The second part is an Access Address. The third part is a packet data unit (PDU). The fourth part is a cyclic redundancy check (CRC). Here, the preamble is one octet (eight data bits, also known as one byte). The Access Address is four octets. The PDU is between two and 39 octets. The CRC is three octets.

As shown in FIG. 2, the PDU includes two main sections. The first is the header, and the second is the payload. The header here has 16 bits (two octets). The payload has a length that is between zero and 37 octets, as per the length field in the header part of the PDU.

The header is shown in FIG. 2 as being divided into six fields. The PDU type field comprises four bits. The phone number addressing (PNA) field comprises two bits. A TxAdd field is one bit. An RxAdd field is one bit. The Length field includes six bits. The sixth field is reserved for future use (RFU) and includes two bits.

The payload section of the PDU includes two main fields. The first is six octets long and is called AdvA. The second part is between zero and 31 octets long and is called AdvData.

The PNA bits in the header of the PDU were reserved for future use (RFU) in version 4.0 of the BLE specification.

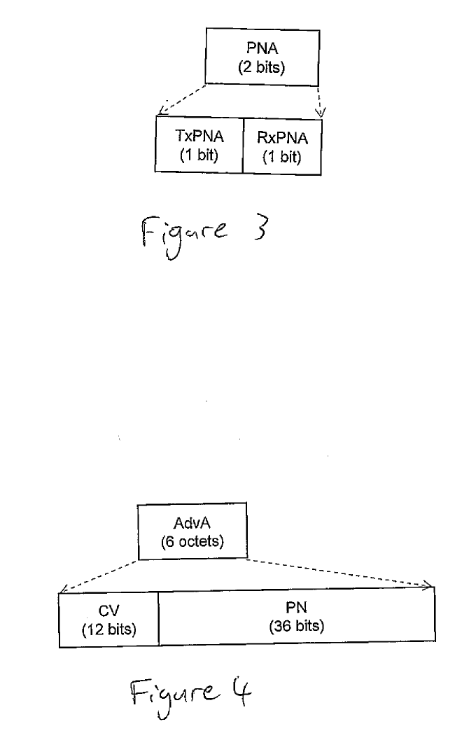

FIG. 3 shows the PNA indication format. The two bits of the PNA field contain a TxPNA bit and an RxPNA bit. If the TxPNA bit is zero, this indicates that the transmitter address uses public/random addressing. A value of 1 in the TxPNA bit indicates that the transmitter address uses PNA (Phone Number Addressing). If the RxPNA bit has a value of zero, this indicates that the receiver address uses public/random addressing. A value of one for the RxPNA bit indicates that the receiver address uses PNA.

The TxAdd and RxAdd fields in the header of the advertising channel PDU contain information specific to the PDU type defined for each advertising channel PDU, separately. For example, with the exemplary PDU type of FIG. 2, the TxAdd may indicate whether the advertiser's address in the AdvA field is public (TxAdd=0) or random (TxAdd=1). In this example, as there is no Rx address defined in the Payload, the RxAdd field will be ignored. If a PDU type defines both Tx address and Rx address in the Payload, such as AdvA and InitA (Initiator Address), then the TxAdd and Rxadd fields are used to indicate the type of the Tx address and Rx address, respectively.

The RxPNA and TxPNA fields provide further information about the address for different types of advertising channel PDUs. For example, with the PDU type of FIG. 2, the TxPNA may indicates whether the advertiser's address in the AdvA field is PNA. (TxPNA=1) or not (TxPNA=0). If the value of TxPNA=1, then the advertiser's address in the AdvA field should be decoded and/or processed as a phone number (or truncated phone number information, as appropriate); otherwise, the TxAdd may be used to indicate if the advertiser's address is public (TxAdd=0) or random (TxAdd=FIG. 4 shows the PNA format. This is the AdvA part of the payload of the PDU, as shown in the first part of the payload in FIG. 2. The AdvA field is 48 bits long, which is six octets. This is the same length as the Device Address field in the Bluetooth standard. This ensures compatibility with the BLE standard in its form at the time of writing.

The PNA field AdvA contains two fields. The first is a counter value (CV) field. This field is 12 bits long. The second field is a phone number (PN) field. The PN field is 36 bits long.

The CV field includes a value that is controlled to start from zero and is controlled to increment every advertising interval. The value of the CV field is incremented by the device 11, 12 that transmits the message. The value in the CV field increments every time a message is transmitted, and thus the payload, the PDU and the overall message is different for every transmission.

There are two advantageous effects of providing the CV field in this way. The first is to provide randomness to the AdvA field, thus providing randomness to the overall message. This means that tracking is more difficult than would otherwise be the case. The second is to enable devices receiving the broadcast message to derive an indication of the period of time for which the broadcasting device has been broadcasting advertising messages.

The provision of the PN field with 36 bits allows a value in the PN field to take any value between zero and 68,719,476,735. This range currently covers all of the phone numbers globally.

The PN field may be provided with the whole of the phone number from the SIM card that is located within the device. Alternatively, the PN field may be provided with a part of the phone number. For instance, the PN field may be provided with the last (end) digits of the phone number. For instance, the PN field may be provided with the last five digits of the phone number. The use of only part of the full number can improve security compared to including the whole of the phone number, for the reason that other devices may not be able to devise the whole of the phone number of the broadcasting device from listening to advertising messages broadcast by the device.

The choice of the number of digits of the phone number that is included in the PN field is a balance between privacy/security of the broadcasting device and its user and the likelihood of a false match being provided when comparing the PN field with phone numbers included in the phonebook database 14, 16. In the case of the PN field including five digits of the phone number of the device, the chance of there being a false match against a given entry in the contacts database 14, 16 is one in 99,999. The number of digits of the phone number that is included in the PN field may alternatively take another value, for instance three, four, six or seven.

If the devices 11, 12 are equipped with two or more SIMs, multiple advertising PDUs can be sent iteratively via BLE radio, each of which contains different PNA data regarding to the phone number of each SIM. As mentioned above, SIMs may be hardware or software.

It has been described above with reference to FIGS. 2, 3 and 4, what form an advertising message takes when generated according to a Phone Number Addressing embodiment of this specification.

In another embodiment, a new Phone Number AD Type is used to communicate phone number information in an advertising message. In this embodiment, the overall message, the header of the PDU and the AdvA of the payload are as shown in and described above in relation to FIG. 2 with one exception. The exception is that the PNA field in the header is not used, and so can remain RFU or can be used for another purpose. The description of FIG. 2 is not repeated here for the sake of conciseness.

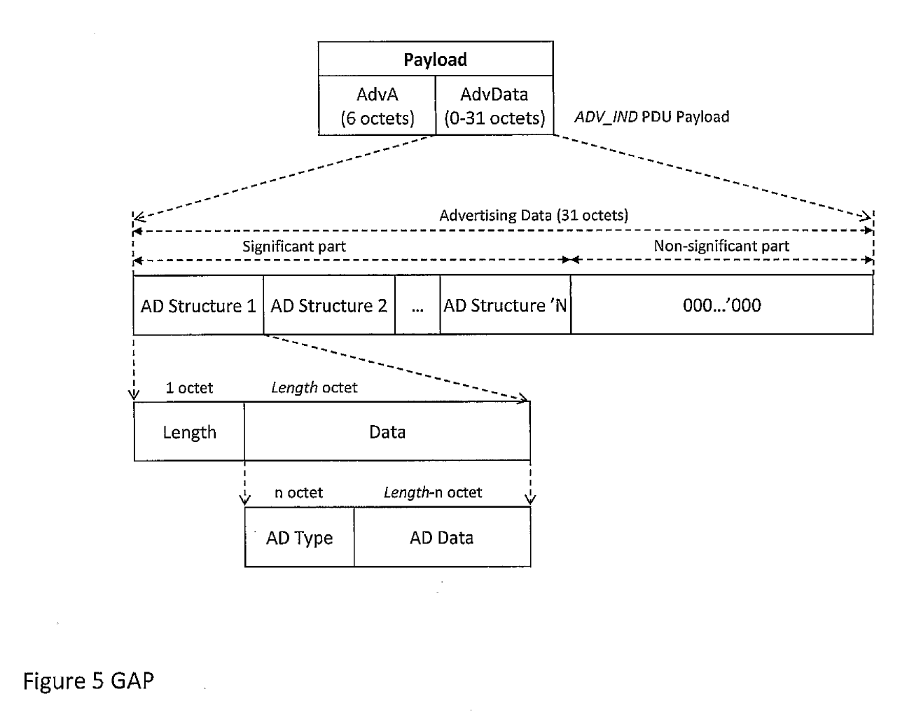

The AdvData part of the payload is different compared to the a Phone Number Addressing embodiment, as will now be described with reference to FIG. 5. FIG. 5 shows the Generic Access Profile (GAP) Advertising Data format. The payload of an advertising PDU includes AdvA and AdvData fields, as shown in both FIG. 2 and FIG. 5. The AdvData field, when applied to GAP, has a fixed length of 31 octets. The AdvData field falls into two parts, a significant part and a non-significant part, both of which are shown in FIG. 5. The significant part carries the advertising data and is encapsulated within multiple AD structures. The non-significant part is all zero bits, that is it includes no information.

In the significant part, each AD structure contains a Length field and a Data field. Each Data field further contains AD Type and AD Data. Definitions of the AD Type and AD Data terms can be found in the Bluetooth Assigned Numbers document that is available at https://www.bluetooth.org/technical/assignednumbers/home.htm at the time of writing.

In this embodiment, a new AD Type is provided. The AD Type is named Phone Number. The format of the Phone Number AD type is as follows:

| Value | Description | Information |
|---|---|---|
| 0x20 | Phone Number | CV (first 12 bits): a counter value (starts from 0, |
| | (6 octets) | and increments every advertising interval) |
| | | PN (last 36 bits): phone number |

The value of the AD Type is here given as 0x20, although it may take some other reserve value. The Phone Number of six octets forms the description of the AD Type. The information is comprised of a Counter Value (CV) part and a Phone Number (PN) part. As with the embodiment shown in FIG. 4, the CV has 12 bits and the PN has 36 bits.

The provision of the PN field with 36 bits allows a value in the PN field to take any value between zero and 68,719,476,735. This range currently covers all of the phone numbers globally.

The PN field may be provided with the whole of the phone number from the SIM card that is located within the device. Alternatively, the PN field may be provided with a part of the phone number. For instance, the PN field may be provided with the last (end) digits of the phone number. For instance, the PN field may be provided with the last five digits of the phone number. The use of only part of the full number can improve security compared to including the whole of the phone number, for the reason that other devices may not be able to devise the whole of the phone number of the broadcasting device from listening to advertising messages broadcast by the device.

The Phone Number AD Type is included in the message in the manner shown in FIG. 5. In particular, the significant part includes a first AD structure named AD structure 1. Other AD structures may follow the first AD structure. In the cases where the devices are equipped with two or more SIMs (hardware and/or software), multiple AD structures can be included in the significant part, each of which contains its own CV and the PN data regarding to the phone number of each SIM.

The first AD structure is formed of two fields, namely a Length field and a Data field. The Length field here is one octet in size. The Data field has a length that is defined by the data included in the Length field. In the Data field, there is provided an AD Type field and an AD Data field. The AD Type field is populated with the value for the Phone Number AD Type, which is 0x20 in the example given above. The AD Data field is populated with the phone number data, which is made up of the twelve bits of CV and 36 bits of PN in the example above.

Because the length of the AD structure 1 field is variable, and is set by the data included in the Length field, the length of the AD Data field may vary. In this example, the length of the AD field is 48 bits, which is a preferred example, although in other embodiments the AD Data field is different lengths.

In summary, in the embodiment of the Phone Number AD Type, an advertising message transmitted by device 11, 12 is as described and shown above with reference to FIG. 2 (except that there in no PNA field in the header) with the AdvData as shown and described above with relation to FIG. 5.

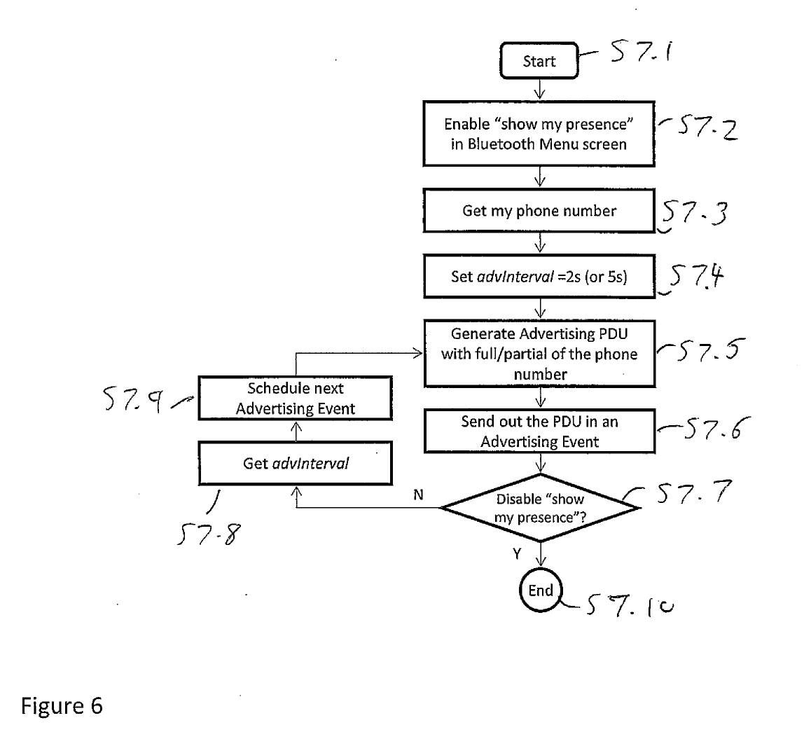

Operation of the devices 11, 12 when in phone number advertiser (PN advertiser) mode will now be described with reference to FIG. 6.

Operation starts at step S7.1. At step S7.2, a “show my presence” feature is enabled. This can be enabled by a user accessing the feature through a Bluetooth menu option provided by the operating system. Alternatively, it may be enabled automatically. Following step S7.2, the phone number of the SIM card is obtained at step S7.3. This may occur in any suitable manner.

At step S7.4, a value of an interval between successive advertisements (the parameter is referred to here as AdvInterval) is set at a suitable value. A suitable value might be two seconds or five seconds, for instance. Following step S7.4, the advertising PDU is generated at step S7.5. The advertising PDU is generated with the whole or part of the phone number that is obtained at step S7.3. The advertising PDU may take the form of the first or the second embodiment described above. The PDU is broadcast in an advertising event at step S7.6.

At step S7.7, it is determined whether the “show my presence” feature is to be disabled. In the event of a negative determination, the operation proceeds to step S7.8. Here, the parameter AdvInterval is obtained. This is the parameter that is set at step S7.4. After the AdvInterval parameter has been obtained at step S7.8, the next advertising event is scheduled at step S7.9. This is scheduled for a time that is later than the time of the immediately succeeding advertisement plus the value of the Advinterval parameter. Following step S7.9, the operation returns to step S7.5, where the advertising PDU is generated.

Step S7.5 produces a different advertising PDU on each occasion. In particular, the value included in the CV field in the AdvA field is incremented each time that step S7.5 is performed. As such, the PDU that is broadcast at step S7.6 is different on each instance of the broadcast advertisement. The CV value may be reset each time that the start step S7.1 is performed.

If at step S7.7 it is determined that the “show my presence” feature is disabled, the operation ends at step S7.10. The “show my presence” feature may be disabled by the user through a menu system or may be disabled automatically by the operating system.

It will be appreciated that step S7.5 may involve generating the advertising PDU using the Phone Number Addressing embodiment described above with reference to FIGS. 2, 3 and 4 or using the Phone Number AD Type embodiment described above with reference to FIGS. 2 and 5.

Also, the part of the phone number that is included in the advertising PDU at step S7.5 may be the whole of the phone number of just a part of the phone number, as described above. As discussed above, the PN field may be provided with the last (end) digits of the phone number. For instance, the PN field may be provided with the last five digits of the phone number. The use of only part of the full number can improve security compared to including the whole of the phone number, for the reason that other devices may not be able to devise the whole of the phone number of the broadcasting device from listening to advertising messages broadcast by the device.

Lastly, the value of the Advinterval parameter can be adjusted according to practical needs. A value of two seconds may be suitable for fast detection of devices. A value of five seconds may be suitable for slow detection of devices.

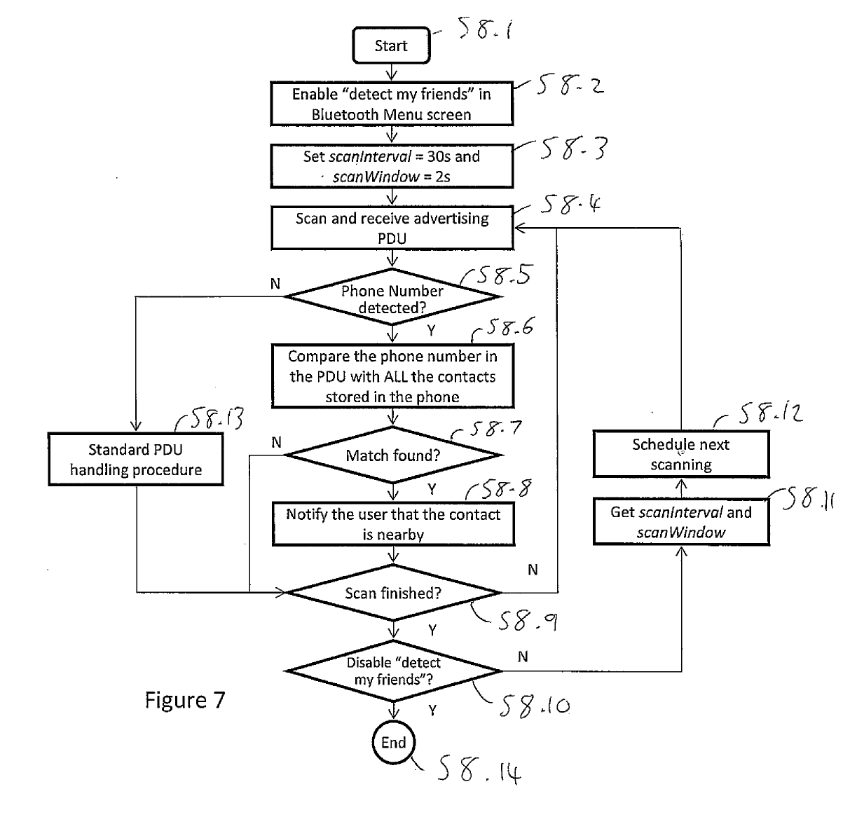

FIG. 7 illustrates operation of a device 11, 12 when scanning for broadcast advertisements.

The operation of FIG. 7 starts at step S8.1. At step S8.2, a “detect my friends” feature is enabled. This may be enabled by a user of the device 11, 12 through a menu system provided by the operating system. Alternatively, it may be enabled automatically by the operating system.

At step S8.3, two parameters are set. The first parameter is an interval between successive scans and is termed ScanInterval. The second parameter relates to the width of a scan window, and is termed ScanWindow. In this example the ScanInterval parameter is set to 30 seconds. The ScanWindow parameter in this example is set to two seconds.

At step S8.4, the device 11, 12 scans and receives advertising PDUs. This step involves operating the BLE module 13, 15 to listen for advertising PDUs that are broadcast by other devices.

At step S8.5, the PDU received in step S8.4 is analysed, and it is determined from the PDU whether a phone number is detected in the PDU. This is performed by examining the PNA bits in the header of the PDU. In particular, it involves examining the TxPNA bit and determining whether the TxPNA bit has a value of one. If it does have a value of one, this indicates that the advertising PDU uses phone number addressing. If it does, the device 11, 12 knows that the AdvA field of the payload of the PDU includes a phone number in the PN field.

Alternatively, if the transmitting device 11, 12 does not use PNA, it may be determined from the AdvData field of the payload that a phone number is included in a phone number AD. This is determined by detecting the value reserved for the phone number AD Type (for instance 0x20) in the AD Data field of the AD structure in the significant part of the AdvData field. If the value of the AD Type indicates that phone number AD Type is used in the advertising PDU, the value of the phone number is obtained by the device 11, 12 from the AD Data field of the same AD structure.

If a phone number is detected at step S8.5, at step S8.6 the device 11, 12 compares the phone number information included in the PDU with the phone numbers for all of the contacts stored in the contacts database 14, 16. S8.6 may involve limiting the comparison to phone numbers that are indicated as being mobile phone numbers, thereby excluding non-mobile phone numbers. This may speed up the search process and reduce the chance of a false match and is possible because only mobile phone numbers may be included in the phone number field of the PDU message. If the received phone number information is a part of a phone number (truncated phone number), this step involves comparing the received phone number information with the appropriate (e.g. end) part of the phone numbers stored in the contacts database 14, 16. If more than one phone number ADs are detected in an advertising PDU, multiple searches are performed. At step S8.7, it is determined whether a match was found at step S8.6.

On a positive determination, the user is notified that the contact is nearby at step S8.8. This involves the device 11, 12 indicating to the user the identity of the contact that includes a phone number matching the phone number information included in the received PDU. This step may be performed in any suitable way. For instance, step S8.8 may involve displaying on a display of the device 11, 12 the name of the contact, as obtained from the contact record in the phonebook database 14, 16, alongside an to indication that a BLE device for the contact is within range of the user's device. Step S8.8 may involve a result refining process. In particular, if multiple matching phone numbers are determined to relate to the same contact, these results may be merged to avoid multiple notifications to the users.

At step S8.9, it is determined whether the scan has been completed. On a positive determination, the operation proceeds to step S8.10. Here, it is determined whether the “detect my friends” feature has been disabled. The feature may be disabled by the user through a menu provided by the operating system or may be disabled automatically by the operating system.

On a negative determination from step S8.10, which occurs when the scan has completed and the “detect my friends” feature has been disabled, the values for the ScanInterval and ScanWindow parameters are obtained at step S8.11. Following obtaining the values, at step S8.12 the next scan is scheduled. The scheduling of the next scan at step S8.12 involves setting the start time of the next scan at a time that is equal to the value of the ScanInterval parameter later than the end of the preceding scan.

Following step S8.12 or following a determination that the scan has not finished at step S8.9, scanning and receiving of advertising PDUs is performed again at step S8.4.

If at step S8.5 a phone number is not detected, which will occur when an advertising message received does not include any phone number AD type or phone number addressing, a standard PDU handling procedure step S8.13 is performed. Following step S8.13, the operation proceeds to step S8.9, where it is determined whether the scan is finished.

Following a determination at step S8.10 that the “detect my friends” feature is disabled, the operation ends at step S8.14.

It will be appreciated that step S8.9 involves determining whether the device 11, 12 has been scanning for a period that is equal to or greater than the value of the ScanWindow parameter. If the scan is not finished, because the scan time is less than the value of the ScanWindow parameter, the operation proceeds from step S8.9 to step S8.4.

If the value included in the PN field of an advertising PDU of the Phone Number Addressing type described with reference to FIGS. 2, 3 and 4 or the phone number in the AD Data field of an advertising message including a Phone Number AD Type, includes fewer digits than is found in a phone number, the comparison of step S8.6 involves comparing the phone number information received in the PDU with a relevant part of the phone numbers stored in the contact database 14, 16. For instance, if the device 11, 12 knows that the phone number information received is the last part of a phone number, the received phone number information is compared against the last part of the phone numbers stored in the phonebook database 14, 16.

The values of the ScanInterval and ScanWindow parameters can take any suitable value. The values chosen for the parameters of ScanInterval and ScanWindow may be chosen as a balance of energy saving for the device 11, 12 in which the operation of FIG. 7 is executed and the latency of detecting BLE devices that are broadcasting advertising messages and are in range of the device 11, 12.

Another embodiment, providing increased security, will now be described. In this embodiment, an advertising PDU is provided with part of the phone number of the device 11, 12 transmitting the PDU, a random number and a hash number. Firstly, the scanning (receiving) device 11, 12 determines if the last three digits of the phone number received from the advertising PDU matches with any of the numbers in the phonebook directory 14, 16. If there is a match, the scanning device calculates the hash value from the random number and the full phone number and then checks if the hash value calculated is equal to the hash value present in the received advertising packet. If a match is found, the user is alerted with the name of the contact from the matching record in the phonebook database 14, 16. This embodiment prevents a rogue device reading phone numbers from PDUs, since only some of the digits are transmitted. It also prevents some rogue device being able to pretend that they are in the phonebook database of a receiving device. This is therefore a secure method of achieving privacy.

Aspects of the invention provide a number of advantages. A first advantage is that both of the embodiments described above are fully compatible with the BLE specification version 4.0. As such, implementing the embodiments is backward compatible with previous versions of the Bluetooth low energy specification.

A key advantage is experienced by users. Instead of users being provided with information that may not allow them to determine BLE devices of interest, they are provided with information relating to contacts, for instance contacts' names, from their contacts database. As such, it will be much easier for users to determine whether a device from which a broadcast advertisement has been received is a device associated with a friend, family member or other associate of the user of the device 11, 12.

The above-described embodiments are seen as having a broad prospect for social applications.

Moreover, the advantages are achieved in the embodiments with a relatively low complexity and with a relatively low overhead of data communication for utilisation of hardware resources.

Although the embodiments are described with reference to Bluetooth Low Energy, it will be appreciated that the concepts may be applicable to other communication protocols. For instance, other embodiments of the invention relate to versions of Bluetooth that are not concerned with the Bluetooth Low Energy aspect of the Bluetooth standard. Other embodiments relate instead to other communication protocols, which may take any suitable form of wireless protocol, whether radio, optical or other.

The embodiments of the invention provide technical effects in that displaying Device Names or Device Addresses to users when initiating communication or pairing between BLE devices can be avoided. Device addresses, though unique, can be inconvenient and obscure for users. Also, using a Device Name can introduce confusion for users when attempting to distinguish different BLE devices.

FIG. 8 shows an example embodiment of a Bluetooth device which may constitute the device 11 or the device 12. Bluetooth device 1301 contains computer code in an executable form 1303 in the memory unit 1302, which may comprise RAM and/or ROM. Memory unit 1302 is connected to one or more processors 1304 on which the instructions are executed. Messages are transmitted and received using a transceiver 1305. Transceiver 1305 is connected to an antenna 1308 for transmitting and receiving packets from another Bluetooth device. A display 1306 is connected to the processor. Messages are presented to a user of the device 1301 by the processor 1304 causing them to be displayed on the display 1306. Input keys 1307 are provided. The input keys 1307 allow a user to enter information into the device 1301. The input keys 1307 may be hardware keys and/or may be soft or virtual keys provided by a touch screen display or the like. Information can include selection of an option as well as information such as a name or phone number of a contact. A SIM interface 1309 is connected to the processor 1304. The SIM interface is suitable for receiving a SIM card 1310, such that the processor 1304 and the SIM card 1310 may communicate with one another.

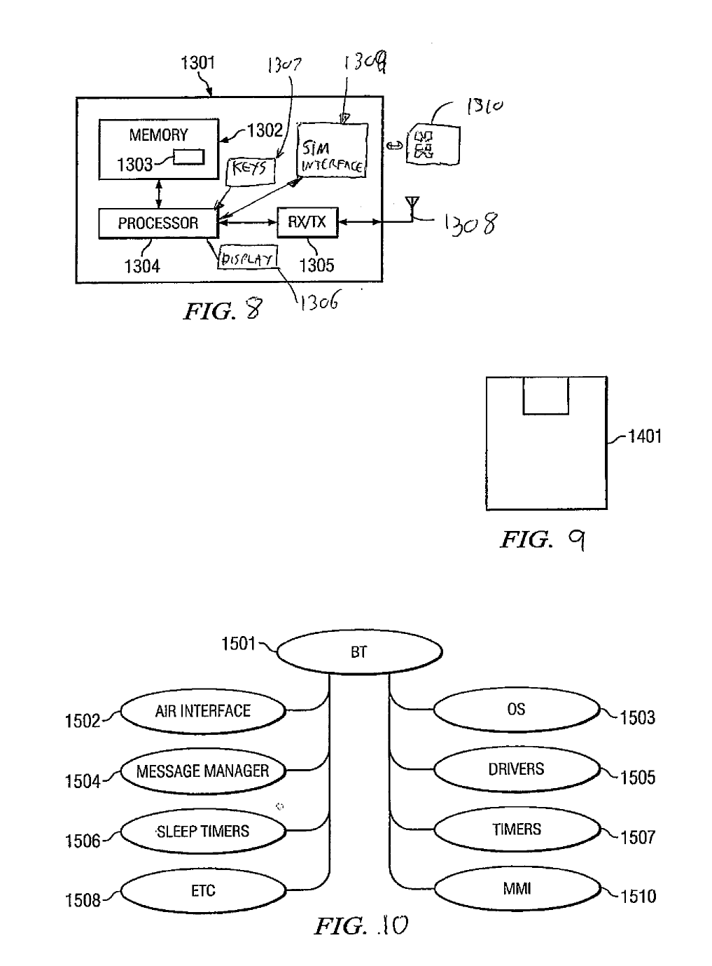

FIG. 9 shows an example embodiment of a tangible memory media. Media 1401 may be a tangible storage media according to the present invention having program content. Media 1401 may be any form of storage media such as magnetic, solid state, optical media, and/or the like.

FIG. 10 shows a software SW view of an example embodiment of a Bluetooth device. This figure shows an example of the main software components that may be implemented on such an apparatus or device.

In this software SW view the apparatus has an operating system OS 1503 and hardware HW drivers 1505. The OS timers used by the OS functions are shown in 1507. The man machine interface MMI, which may be a single button or several buttons, is shown in 1510. This utilises the display 1306 and the keys 1307.

The interface specific components are a Bluetooth BT radio interface protocol control stack 1501, an actual air interface 1502 which is controlled by the drivers 1505 to select RX or TX, and a message manager 1504 which controls the Bluetooth message structures and queues.

Further, the apparatus may comprise at least a sleep timer 1506. Timers 1507 may be used to schedule scan and advert broadcast activities, as described above with reference to FIGS. 6 and 7. The apparatus may comprise other SW components 1508, for example a BT profile manager. The BT profile manager may manage the mode the device is in, define additional messages it may be expected to provide or respond too, etc. A device may be simple and have only one profile. Alternatively, a device may be more complex and have or support several profiles.

The apparatus may comprise further optional SW components which are not described in this specification since they may not have direct interaction to embodiments of the invention.

Embodiments of the present invention may be implemented in software, hardware, application logic or a combination of software, hardware and application logic. The software, application logic and/or hardware may reside on memory 1302, or any computer media of which an example is shown as 1401. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 8.

A computer-readable medium, as depicted in FIG. 9, may comprise a computer-readable storage medium that may be any tangible media or means that can contain or store the instructions for use by or in connection with an instruction execution system, apparatus, or device, such as a computer as defined previously.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

For instance, although in the above information is said to be displayed on a display of the device, it may instead be projected or displayed as a hologram or may be presented audibly or in any other suitable way.

1-47. (canceled)

48. An apparatus comprising at least one processor and at least one memory including computer program code, the at least one memory and the computer program code are configured, with the at least one processor, to cause the apparatus at least:
to receive an advertisement packet data unit (PDU);
to determine from the PDU whether the PDU includes telephone number data as an identifier of a device from which the PDU was transmitted; and
in response to a positive determination:
to extract the telephone number data from the PDU;
to compare the telephone number data with telephone numbers present in a contacts database; and
in the event of the comparison providing a match, to cause the presentation of information from the contacts database relating to the contact with which the match was found.

49. The apparatus as claimed in claim 48, the at least one memory and the computer program code configured, with the at least one processor, to further cause the apparatus at least to, in response to a negative determination, cause presentation of device name information included in the PDU.

50. The apparatus as claimed in claim 48, the at least one memory and the computer program code configured, with the at least one processor, to further cause the apparatus at least, in the event of the comparison providing a match, to cause presentation of contact name information from the contacts database relating to the contact with which a match was found.

51. The apparatus as claimed in claim 48, wherein the telephone number data comprises at least one of the following:
a part of a telephone number less than a whole of a telephone number, or
a whole of a telephone number.

52. The apparatus as claimed in claim 48, wherein the contacts database is stored within the apparatus, or is stored within a SIM card included within the apparatus.

53. An apparatus comprising at least one processor and at least one memory including computer program code, the at least one memory and the computer program code are configured, with the at least one processor, to cause the apparatus at least:
to create an advertising message including a packet data unit (PDU) including telephone number information derived from a telephone number associated with the apparatus and an indication that the PDU includes telephone number information; and
to transmit the advertising message.

54. The apparatus as claimed in claim 53, the at least one memory and the computer program code configured, with the at least one processor, to further cause the apparatus at least:
to include the telephone number information in a phone number field and include a counter value in a counter value field; and
to change the counter value included in the counter value field between creation of successive advertising messages.

55. The apparatus as claimed in claim 54, wherein the counter value field is 12 bits or wherein the phone number field is 36 bits.

56. A non-transitory computer-readable medium encoded with instructions executable by a processor to perform actions comprising:
extracting telephone data number data from a received advertisement packet data unit (PDU);
comparing the telephone number data with telephone numbers present in a contacts database; and
in the event of the comparison providing a match, causing presentation of information from the contacts database relating to a contact with which a match was found.

57. The computer-readable medium as claimed in claim 56, further encoded with instructions executable by a processor to perform actions comprising:
in response to a negative determination, causing presentation of device name information included in the PDU.

58. The computer-readable medium as claimed in claim 56, further encoded with instructions executable by a processor to perform actions comprising:
causing presentation of contact name information from the contacts database relating to the contact with which a match was found.

59. The computer-readable medium as claimed in claim 56, wherein the telephone number data comprises at least one of the following:
a part of a telephone number less than a whole of a telephone number, or
a whole of a telephone number.
